(19) United States
(12) Patent Application Publication
(10) Pub. No.: US 2020/0167342 A1
(43) Pub. Date: May 28, 2020

(54) System for Secure Software Defined Networking Based on Block-Chain and Method Thereof

(71) Applicant: Korea Advanced Institute of Science and Technology, Daejeon (KR)

(72) Inventors: Seungwon SHIN, Daejeon (KR); Seungwon WOO, Daejeon (KR)

(73) Assignee: Korea Advanced Institute of Science and Technology, Daejeon (KR)

(21) Appl. No.: 16/693,720

(22) Filed: Nov. 25, 2019

(30) Foreign Application Priority Data
Nov. 26, 2018 (KR) 10-2018-0146946

(51) Int. Cl. G06F 16/23; H04L 29/06; H04L 12/947

(52) U.S. Cl. CPC G06F 16/2379; H04L 67/1097; H04L 49/25; H04L 63/1416

(57) ABSTRACT

The inventive concept relates to a technology of sharing data between distributed SDN controllers using block-chain, and it is possible to effectively and flexibly process the security problems through a block chain-based SDN by providing fault-tolerant, verification, and debugging.

### CROSS-REFERENCE TO RELATED APPLICATIONS

A claim for priority under 35 U.S.C. § 119 is made to Korean Patent Application No. 10-2018-0146946 filed on Nov. 26, 2018, in the Korean Intellectual Property Office, the entire contents of which are hereby incorporated by reference.

### BACKGROUND

Embodiments of the inventive concept described herein relate to a secure software-defined networking (SDN) system based on a block-chain and a method thereof, and more particularly, relate to a technology of sharing data between distributed SDN controllers using block-chain.

Unlike the conventional network equipment such as the conventional switch, or the conventional router, the SDN technology refers to a technology of providing network services while being separated into a control plane that determines how data is delivered and a data plane that actually delivers data based on rules determined by the control plane. The separated control plane and data plane communicate with each other through a protocol called “openflow” and are implemented with the centralized structure in which one or more SDN controllers manage several switches.

The basic flow is as follows. First, when a packet enters the switch managed by the SDN controller, the flow table of the switch is first identified. When there is no flow rule matched to the packet entered in the flow table, the switch delivers the corresponding packet to the SDN controller, using the openflow protocol. The SDN controller receives the packet and determines how to process the packet and then delivers the flow rule to the switch; the switch stores the corresponding flow rule in the flow table and processes packets received subsequently without going through the SDN controller.

Because the SDN manages a large number of switches with this centralized structure, the SDN may provide various network services to be suitable for the current network status and these network functions may be implemented in the form of an application of an SDN controller. Because the SDN may provide a service such as firewall, IDS, or IPS more flexibly than the conventional SDN, the SDN may provide many network users with high security. However, in an SDN environment, when a problem occurs in the SDN controller, the whole network may be interrupted due to this centralized structure.

Accordingly, the conventional SDN technology supports the distributed controller to solve this problem.

Several switches in an SDN environment may be managed by a single SDN controller, or may also be managed through several SDN controllers. The main reason for using the distributed SDN controller is fault-tolerant. The main drawback in SDN environments is that the switches managed by the corresponding controller cannot process any new packets when the centralized SDN controller is stopped due to a network attack such as DDoS or an error is generated by the problem of a controller internal logic; this may seriously affect the whole network. When one controller is terminated due to a problem, another controller may manage switches instead of the terminated controller by introducing the distributed SDN controller to solve this problem. For the purpose of supporting such the distributed controller, a plurality of controllers need to have the same data while communicating with one another.

The conventional technology generates a single database to maintain the same data, and several controllers access the database to manage a flow rule, switch information, or the like. However, in this case, the speed is restricted because a plurality of controllers access the single database; as with the conventional technology, when there is a problem, the advantages offered by the distributed controller are eliminated. Another method is a method of maintaining the same data for each distributed controller. However, in this case, there is a problem that a specific controller may maliciously revise or delete data.

There is a prior art disclosed as Korean Patent Publication No. 10-2016-0090485 (published on Aug. 1, 2016), “METHOD AND DEVICE FOR OPERATING DISTRIBUTED CONTROLLER IN SOFTWARE-DEFINED NETWORK”.

### SUMMARY

Embodiments of the inventive concept provide a method in which a plurality of distributed SND controllers store and deliver data while having the same block-chain.

Furthermore, embodiments of the inventive concept provide a block chain-based SDN capable of effectively and flexibly processing the security problems, which occur in the conventional technology, by providing fault-tolerance, verification, and debugging.

According to an exemplary embodiment, a block chain-based secure software-defined networking (SDN) system includes a master controller, which is a single SDN controller among a plurality of SDN controllers, and which is configured to generate a block depending on a block generation time to add the block to a block-chain and a slave controller, which is at least one or more SDN controllers other than the master controller among the plurality of SDN controllers and which performs a verification process on whether a resource updated through an openflow message with a switch is matched to a transaction of the generated block. The master controller and the slave controller are formed of the same block-chain.

The master controller is only the single SDN controller among the plurality of SDN controllers, and the slave controller is all SDN controllers other than the master controller among the plurality of SDN controllers, and is a replica providing the same network function as the master controller.

The plurality of SDN controllers including the master controller and the slave controller include a block-chain in which a plurality of blocks are connected, and each of the plurality of blocks is composed of ‘Previous Hash’, ‘Block Number’, ‘Timestamp’, and ‘Transaction’.

The transaction is formed in plural in each of the plurality of blocks, and includes ‘Type’, ‘Key/Value’, ‘State’, and ‘Timestamp’.

The master controller generates a new block in the master controller to add the new block to the block-chain depending on the block generation time predetermined by a network administrator.

The master controller generates the transaction to construct a block and updates the constructed block in the block-chain.

The master controller updates information of the plurality of SDN controllers and information of the switch in the block-chain and updates a flow table and a group table inside the switch through the openflow message.

The slave controller identifies a resource updated inside the switch through the openflow message, and performs the verification process on determining whether the updated resource is matched to the transaction of the block generated by the master controller. The plurality of SDN controllers determine and exclude an unverified master controller or an unverified slave controller, as a malicious controller when more than half of the slave controller being the at least one or more SDN controllers fails to extract the same result for the verification process.

According to an exemplary embodiment, a method of operating a block chain-based secure SDN system includes generating a block to add the block to a block-chain depending on a block generation time, using a single master controller among a plurality of SDN controllers and performing a verification process on whether a resource updated through an openflow message with a switch is matched to a transaction of the generated block, using at least one or more slave controllers other than the master controller among the plurality of SDN controllers. The master controller and the slave controller are formed of the same block-chain.

Furthermore, the method of operating a block chain-based secure SDN system further includes determining and excluding an unverified master controller or an unverified slave controller as a malicious controller depending on the result for the verification process.

The determining and the excluding includes determining and excluding the unverified master controller or the unverified slave controller as the malicious controller, when more than half of the slave controller being the at least one or more SDN controllers fails to extract the same result for the verification process.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 illustrates an example in which adverse effects are caused by malicious programs in the conventional SDN environment;

FIG. 2 illustrates a configuration of a block chain-based secure SDN system, according to an embodiment of the inventive concept;

FIG. 3 illustrates a structure of a block-chain used in a distributed SDN controller, according to an embodiment of the inventive concept;

FIG. 4 illustrates a list of transactions in a block, according to an embodiment of the inventive concept; and

FIG. 5 illustrates a flowchart a method of operating a block chain-based secure SDN, according to an embodiment of the inventive concept.

### DETAILED DESCRIPTION

Hereinafter, exemplary embodiments of the inventive concept will be described in detail with reference to the accompanying drawings. However, the inventive concept is neither limited nor restricted by the embodiments. Further, the same reference numerals in the drawings denote the same members.

Furthermore, the terminologies used herein are used to properly express the embodiments of the inventive concept, and may be changed according to the intentions of a viewer or the manager or the custom in the field to which the inventive concept pertains. Therefore, definition of the terms should be made according to the overall disclosure set forth herein.

The inventive concept refers to a block chain-based SDN capable of effectively and flexibly processing the security problem, which occurs in the conventional technology, by providing fault-tolerance, verification, and debugging.

The inventive concept may solve three security problems capable of occurring in the conventional distributed SDN environment.

First, it is possible to flexibly provide fault-tolerance. The SDN controller may not provide proper network services owing to network attacks, for example, DDoS, or the issue of internal logic that a controller is not working due to incorrect implementation of a controller or an internal application. Accordingly, when this problem occurs, another SDN controller may be replaced efficiently.

Second, a verification process may be provided to prevent the malicious behavior by malicious controllers and applications. In the conventional distributed SDN environment, an attacker may install the malicious controllers or applications to perform malicious behaviors such as installing flows or blocking a specific IP address, which are unwanted by a network administrator. Accordingly, to this end, another distributed SDN controller may provide a mechanism that prevents this problem by verifying each behavior.

Finally, it may be possible to efficiently provide debugging when a problem with the network service occurs. The inventive concept may record a timestamp for the network resource that are added and changed by the proposed block-chain transaction. In addition, because the data may not be revised when the data is stored in the block-chain, the malicious controller may not revise old data. Accordingly, it is possible to perform effective debugging through this unrevisable past history.

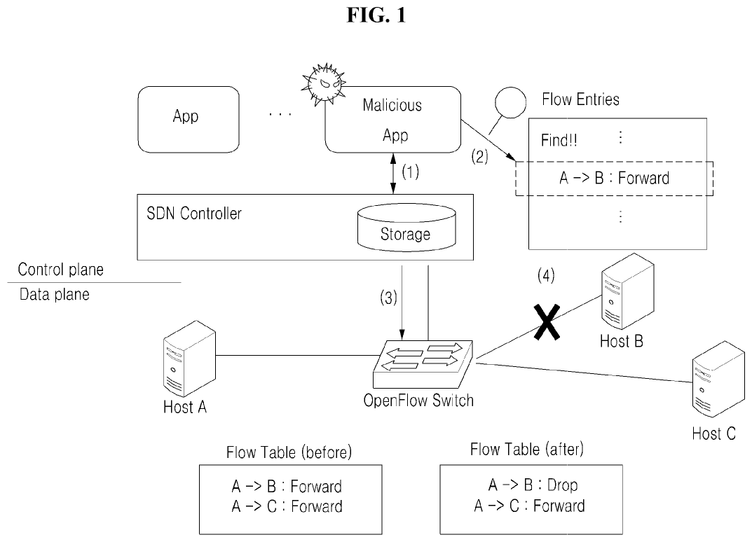

Hereinafter, according to an embodiment of the inventive concept, a block chain-based secure SDN system and a method thereof will be described in detail with reference to FIGS. 1 to 5.

FIG. 1 illustrates an example in which adverse effects are caused by malicious programs in the conventional SDN environment.

Referring to FIG. 1, a malicious program (Malicious App) in the SDN environment may communicate (1) with the SDN Controller and then may grasp (2) dataflow from host ‘A’ to host ‘B’.

The malicious program may arbitrarily control (3) the function of the openflow switch that processes the packet in the data plane through the SDN controller and then may block (4) data from host ‘A’ to host ‘B’.

Herein, the openflow switch is responsible for only the transmitting and receiving function of the packet; packet path setting, management and control are all made in the SDN controller. Accordingly, the malicious program in the SDN environment may adversely affect the whole SDN environment through the SDN controller.

Referring to the flow table in the SDN environment illustrated in FIG. 1, it is identified that data transmission from host ‘A’ to host ‘C’ is normally made but data transmission from host ‘A’ to host ‘B’ is dropped.

As illustrated in FIG. 1, network programs in the conventional SDN environment may be operated without any limitation. Therefore, the network administrator needs to determine whether the corresponding program is malicious or normal before installing the corresponding program.

At this time, the SDN controller may be implemented in a form in which software that performs functions such as topology management, path management associated with packet processing, link discovery, flow management, or the like is mounted in the manner of the module.

Also, the openflow switch exchanges information with the SDN controller via a secure channel. The secure channel is a communication channel between the switch and the SDN controller positioned at a distance, and the information exchanged between the SDN controller and the switch may be encrypted.

In the openflow switch, there are one or more flow tables that define and process the packet and include statistical information associated with the packet. The flow table is composed of flow rules that define packet processing; the flow rule may be added, revised, or deleted by the flow-mod message, which is generated and transmitted to the openflow switch by the SDN controller.

The openflow switch processes the packet with reference to the flow table. The flow table may include match information (Match Field) about the packet defining the flow, operation information (Instruction) for defining the processing of the packet, and statistics information (Stats) for each flow. In addition, each row of the flow table is called a “flow entry”; a priority may be assigned to each flow entry. The switch may process the packet depending on the operation information of the flow entry having the highest priority among the flow entries having match information matched to the information of a packet.

Furthermore, a host refers to a terminal corresponding to a lower layer of a switch, and may be used to collectively mean a client and a server. The host may generate a packet to be transmitted to another host via the SDN and then may transmit the packet to the switch via the port of the network interface.

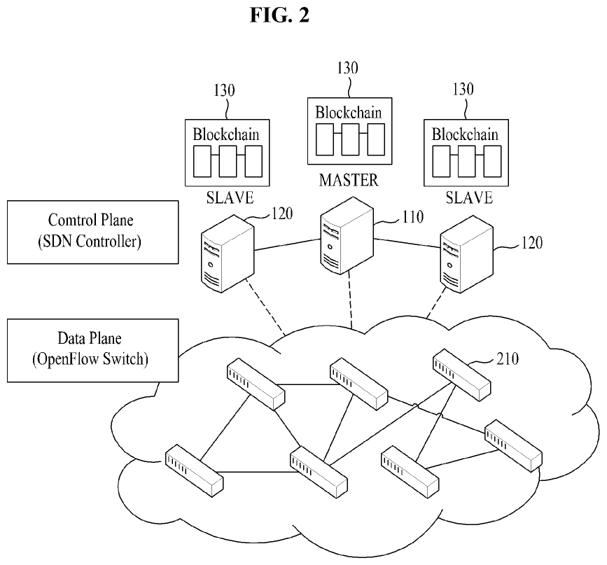

FIG. 2 illustrates the configuration of a block chain-based secure SDN system, according to an embodiment of the inventive concept.

Referring to FIG. 2, the block chain-based secure SDN system according to an embodiment of the inventive concept provides data sharing between distributed SDN controllers via the block chain-based SDN, and thus provides fault-tolerance, verification, and debugging to efficiently handle security problems.

To this end, the block chain-based secure SDN system according to an embodiment of the inventive concept includes a master controller 110 and a slave controller 120. At this time, the master controller 110 and the slave controller 120 are formed of the same block-chain.

Referring to FIG. 2, the master controller 110 and the slave controller 120, which are SDN controllers, are located on the control plane. The distributed SDN controller has a master-slave structure. Herein, the master controller 110 is referred to as only the single SDN controller of a plurality of SDN controllers (e.g., SDN controllers that includes both the master controller 110 and the slave controller 120); the slave controller 120 is referred to as all SDN controllers other than the master controller 110 among a plurality of SDN controllers. That is, the slave controller 120 may be at least one or more SDN controllers.

At this time, the slave controller 120 may be a replica that provides the same network function as the master controller 110. For this reason, the SDN application operating in the master controller 110 operates in the slave controller 120 as it is.

Each of the master controller 110 and the slave controller 120 may include a block-chain 130 to which a plurality of blocks are connected; each of a plurality of blocks may be composed of the hash value (previous hash) of the previous block, a block number, a timestamp, and a transaction. At this time, a plurality of transactions may be formed in each of a plurality of blocks; each transaction may include ‘Type’, ‘Key/Value’, ‘State’, and ‘Timestamp’.

In more detail, the master controller 110 and the slave controller 120 will be described below. The master controller 110 is the single SDN controller among a plurality of SDN controllers and generates a block depending on a block generation time and adds the block to the block-chain 130.

The master controller 110 may generate a new block in the master controller 110 and may add the new block to the block-chain, depending on the block generation time set by a network administrator. For example, the master controller 110 may generate a transaction to construct a block and then may update and add the constructed block to the block-chain.

Only the master controller 110 may generate the block to add the block to the block-chain 130. At this time, the block generation time may be set by the network administrator; when the transaction does not occur within the generation time, the master controller 110 does not generate a block and waits for the time set again.

The master controller 110 may update the information of all SDN controllers including the master controller 110 and the slave controller 120 and the information of a switch 210 in the block-chain 130, may update a flow table and a group table inside the switch 210 via an openflow message, may generate a transaction to construct a block, and may update the block in the block-chain 130. Herein, when the master controller 110 generates a block in the master controller 110 to update and add the block to the block-chain and then updates each information and table in the block-chain, the plurality of slave controllers 120, each of which is a replica, may form the block-chain updated to be the same as the master controller 110.

The slave controller 120 is at least one or more SDN controllers other than the master controller 110 among a plurality of SDN controllers, and performs a verification process on whether the resource updated through an openflow message exchanged with the switch 210 is matched to the transaction of the generated block.

For example, the slave controller 120 may determine which resource is updated inside the switch 210 through the openflow message exchanged with the switch 210 and may perform a verification process on whether the updated resources are matched to the transactions in the block newly generated by the master controller 110. At this time, more than half of at least one or more slave controllers 120 needs to extract the same result; when it is impossible to extract the same results for the verification process, the master controller 110 or the slave controller 120 that has not been verified may be determined as a malicious controller and then may be excluded. At this time, the master controller 110 or the slave controller 120 determined as the malicious controller may be determined to be the wrong behavior.

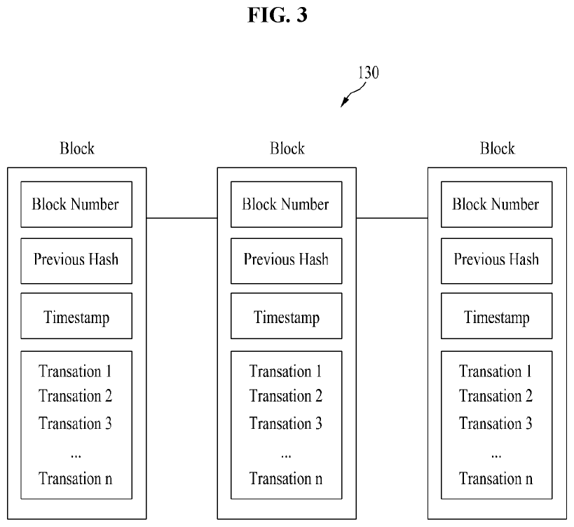

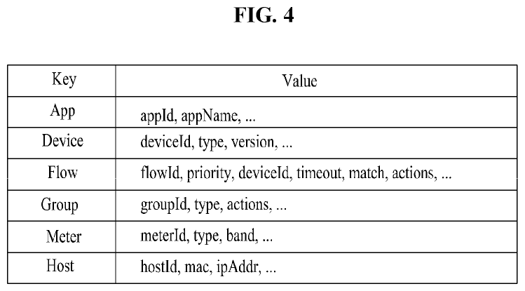

FIG. 3 illustrates the structure of a block-chain used in a distributed SDN controller, according to an embodiment of the inventive concept. FIG. 4 illustrates a list of transactions in a block, according to an embodiment of the inventive concept.

Referring to FIG. 3, all distributed SDN controllers including a master controller and a slave controller include the same block-chain 130.

The whole structure of the block-chain 130 is as illustrated in FIG. 3, and the block-chain 130 consists of a structure composed of a single chain while a single block refers to the previous block. One block in the block-chain 130 stores the data to be managed, and the behavior such as adding, deleting, and revising data is stored as one transaction unit.

In general, one block is composed of a block number, information of several transactions, a timestamp, and the hash value (previous hash) of the previous block. In the case of the first block, the previous hash value is not present; the block is constructed to include the previous hash value whenever a subsequent block is generated.

The block-chain 130 features a decentralized structure; because the slave controller as well as the master controller stores the same information, there is no need to manage the centralized database. Furthermore, even when a malicious user revises specific data, a plurality of other SDN controllers may verify the information about the corresponding data; because the entire hash values are changed due to the nature of the hash value when the data written in the previous block is changed, it is easy to detect the change of data. Accordingly, it is impossible to change information about previous records due to the nature of the block-chain.

FIG. 4 illustrates a list of transaction key/value of the switch type.

One block constituting the block-chain 130 includes a plurality of transactions; one transaction includes ‘Type’, ‘Key/Value’, ‘State’, and ‘Timestamp’.

First of all, the type indicates two types of controllers or switches.

In the case of a controller, the type of the controller is a transaction capable of defining which SDN controller is the master MASTER or the slave SLAVE. At this time, ‘Value’ indicates the IP address of each SDN controller; the master controller includes only the single ‘Value’ but the slave controller includes a plurality of ‘Values’.

As illustrated in FIG. 4, in the case of switch, a transaction may indicate several keys such as ‘App’, ‘Device’, ‘Flow’, ‘Group’, ‘Meter’, ‘Host’, and the like and may include data for each corresponding resource as ‘Value’.

‘State’ indicates two states of addition (ADD) or removal (REMOVE); whenever each resource is added and deleted, the single state is stored in the block-chain 130.

‘Timestamp’ indicates the generation time of the corresponding transaction.

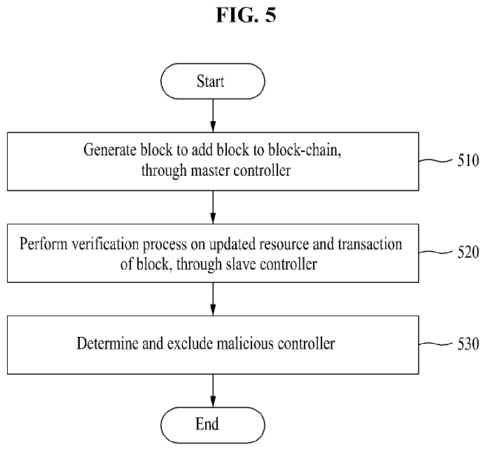

FIG. 5 illustrates a flowchart a method of operating a block chain-based secure SDN, according to an embodiment of the inventive concept.

Referring to FIG. 5, in operation 510, it is possible to generate a block to add the block to a block-chain depending on a block generation time, using a single master controller among a plurality of SDN controllers.

The master controller may generate a new block in the master controller to add the new block to the block-chain, depending on the block generation time set by a network administrator. For example, the master controller may generate a transaction to construct a block and then may update and add the constructed block to the block-chain.

Only the master controller may generate the block to add the block to the block-chain. At this time, the block generation time may be set by the network administrator; when the transaction does not occur within the generation time, the master controller does not generate a block and waits for the time set again.

In operation 520, it is possible to perform a verification process on whether a resource updated through an openflow message with a switch is matched to a transaction of the generated block, using at least one or more slave controllers other than the master controller among a plurality of SDN controllers. At this time, the master controller and the slave controller are formed of the same block-chain.

Afterward, in operation 530, the master controller or the slave controller that has not been verified may be determined as a malicious controller and then may be excluded, depending on the result for the verification process.

In operation 530, when more than half of slave controllers being at least one or more SDN controllers fails to extract the same result for the verification process, the master controller or the slave controller that has not been verified may be determined as the malicious controller and then may be excluded.

For example, the slave controller may determine which resource is updated inside the switch through the openflow message exchanged with the switch and may perform a verification process on whether the updated resources are matched to the transactions in the block newly generated by the master controller. At this time, more than half of at least one or more slave controllers needs to extract the same result; when it is impossible to extract the same results for the verification process, the master controller or the slave controller that has not been verified may be determined as a malicious controller and then may be excluded. At this time, the master controller or the slave controller determined as the malicious controller may be determined to be the wrong behavior.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may perform an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and be stored or executed in a dispersion manner. Software and data may be recorded in one or more computer-readable storage media.

The methods according to the above-described exemplary embodiments of the inventive concept may be recorded in computer-readable media including program instructions to implement various operations embodied by a computer. The computer-readable medium may also include the program instructions, data files, data structures, or a combination thereof. The program instructions recorded in the media may be designed and configured specially for the exemplary embodiments of the inventive concept or be known and available to those skilled in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like. The described hardware devices may be configured to act as one or more software modules to perform the operations of the above-described exemplary embodiments of the inventive concept, or vice versa.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

According to an embodiment of the inventive concept, it is possible to provide a block chain-based SDN for providing a method in which a plurality of distributed SND controllers store and deliver data while having the same block-chain.

Moreover, according to an embodiment of the inventive concept, it is possible to more effectively provide fault-tolerance and verification through the block chain-based SDN; in addition, reliable debugging is possible because not only the history of a specific resource but also the integrity that cannot be forged by a malicious user are provided.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A block chain-based secure software-defined networking (SDN) system, the system comprising:
a master controller, which is a single SDN controller among a plurality of SDN controllers, and which is configured to generate a block depending on a block generation time to add the block to a block-chain; and
a slave controller, which is at least one or more SDN controllers other than the master controller among the plurality of SDN controllers and which performs a verification process on whether a resource updated through an openflow message with a switch is matched to a transaction of the generated block,
wherein the master controller and the slave controller are formed of the same block-chain.

2. The system of claim 1, wherein the master controller is only the single SDN controller among the plurality of SDN controllers, and
wherein the slave controller is all SDN controllers other than the master controller among the plurality of SDN controllers, and is a replica providing the same network function as the master controller.

3. The system of claim 1, wherein the plurality of SDN controllers including the master controller and the slave controller include a block-chain in which a plurality of blocks are connected, and
wherein each of the plurality of blocks is composed of ‘Previous Hash’, ‘Block Number’, ‘Timestamp’, and ‘Transaction’.

4. The system of claim 3, wherein the transaction is formed in plural in each of the plurality of blocks, and includes ‘Type’, ‘Key/Value’, ‘State’, and ‘Timestamp’.

5. The system of claim 3, wherein the master controller generates a new block in the master controller to add the new block to the block-chain depending on the block generation time predetermined by a network administrator.

6. The system of claim 5, wherein the master controller generates the transaction to construct a block and updates the constructed block in the block-chain.

7. The system of claim 1, wherein the master controller updates information of the plurality of SDN controllers and information of the switch in the block-chain and updates a flow table and a group table inside the switch through the openflow message.

8. The system of claim 1, wherein the slave controller identifies a resource updated inside the switch through the openflow message, and performs the verification process on determining whether the updated resource is matched to the transaction of the block generated by the master controller, and
wherein the plurality of SDN controllers determine and exclude an unverified master controller or an unverified slave controller, as a malicious controller when more than half of the slave controller being the at least one or more SDN controllers fails to extract the same result for the verification process.

9. A method of operating a block chain-based secure SDN system, the method comprising:
generating a block to add the block to a block-chain depending on a block generation time, using a single master controller among a plurality of SDN controllers; and
performing a verification process on whether a resource updated through an openflow message with a switch is matched to a transaction of the generated block, using at least one or more slave controllers other than the master controller among the plurality of SDN controllers,
wherein the master controller and the slave controller are formed of the same block-chain.

10. The method of claim 9, further comprising:
determining and excluding an unverified master controller or an unverified slave controller as a malicious controller depending on the result for the verification process.

11. The method of claim 10, wherein the determining and the excluding includes:
determining and excluding the unverified master controller or the unverified slave controller as the malicious controller, when more than half of the slave controller being the at least one or more SDN controllers fails to extract the same result for the verification process.

12. A computer-readable recording medium recorded with a program for executing the method of any one of claim 9 through a computer.
